(19) United States
(12) Patent Application Publication
(10) Pub. No.: US 2002/0114609 A1
(43) Pub. Date: Aug. 22, 2002

(54) Method of stripping an optical fiber and a fiber obtained thereby

(76) Inventors: Fabrice Thebault, Ploubezre (FR); Guillaume Peigne, Roche-Blanche (FR); Stephane Rio, Quiberon (FR); Johann Caffiau, Ile-Grande (FR)

Correspondence Address: FROMMER LAWRENCE & HAUG LLP, 745 Fifth Avenue, New York, NY, 10151, US

(21) Appl. No.: 10/079,446

(22) Filed: Feb. 19, 2002

(30) Foreign Application Priority Data
Feb. 20, 2001 (FR) 0102255
Feb. 5, 2002 (EP) 02290263.9

(51) Int. Cl. G02B 6/00; B26D 7/06

(52) U.S. Cl. 385/147; 385/134; 83/23

(57) ABSTRACT

The present invention relates to a method of stripping an optical fiber, the method comprising the steps consisting in: locally and mechanically removing a portion of the outer covering of the fiber; placing a chemical solvent on the periphery of said zone of the fiber; and mechanically removing the covering(s) weakened in this way.

The present invention relates to the field of optical fibers.

More precisely, it relates to the field of stripping optical fibers.

### BACKGROUND OF THE INVENTION

An optical fiber generally comprises three portions: a core 10, cladding 20, and plastics coverings 30, as shown diagrammatically in FIG. 1. Typically, the diameter of the cladding 20 is about 125 micrometers (μm) whereas the coverings 30 have a diameter of about 200 μm to 450 μm.

The core 10 which is the optically active portion is generally made of doped silica (SiO₂), e.g. silica doped with germanium (Ge).

The cladding 20, which serves as “insulation” in transporting light energy, is generally made of pure silica.

The coverings 30 protect the bare fiber (core 10+cladding 20) from mechanical and chemical stresses in the surroundings. In this respect, they need to provide a barrier against the environment (water, ultraviolet (UV) radiation, . . . ).

Mechanical stresses include, amongst other things, bending, microbending (local deformations of the core/cladding interface), crushing, traction, abrasion, and twisting. These stresses can give rise to transmission losses and to a reduction in mechanical characteristics.

Chemical stresses are due in particular to water and to hydrogen which degrade the fiber over time. For example, the action of water on microcracks present in the silica leads to a reduction in mechanical strength and thus to a reduction in fiber lifetime. Similarly, hydrogen diffusion into the silica gives rise to an increase in transmission losses.

To counter such stresses, it is conventional for a fiber to be protected by two polymer coverings 30: a primary covering which is flexible, made of acrylate or urethane acrylate, and which serves to protect the fiber most particularly against microbending, and a secondary covering which is harder, being made of epoxy acrylate or urethane epoxy acrylate, which serves to protect the fiber against external stresses.

Known coverings 30 typically make it possible for the fiber to present traction strength of about 6 decanewtons (daN).

The person skilled in the art can usefully refer to documents [1], [2], and [3] which relate in particular to optical fibers and to making components therewith.

Although destruction of the coverings, even if localized, greatly weakens the optical fiber (e.g. subjects it to stresses from the surroundings such as water (hydrolysis phenomenon), encouraging the microcracks present in the surface of the silica to propagate), it is sometimes necessary to strip optical fibers locally in order to take action thereon, for example in order to make a Bragg grating.

Stripping consists in locally removing the covering(s) from the optical fiber.

Various stripping techniques have already been proposed. Nevertheless, none of them gives full satisfaction.

In particular, present stripping techniques do not guarantee any conservation of traction strength and they do not make it possible to ensure any degree of repeatability.

For example, the use of stripping pliers [4] gives rise to a drop in the mechanical characteristics of the optical fiber, including its traction strength. This deterioration is a consequence of direct physical contact between the core/cladding assembly and the pliers, causing microcracks to appear at the surface of the silica. The microcracks are then subject to a propagation phenomenon which weakens fibers that have been stripped in this way.

### OBJECTS AND SUMMARY OF THE INVENTION

An object of the present invention is to propose a novel method of stripping optical fibers.

A particular object of the present invention is to provide a stripping method that does not require any rise in temperature so as to guarantee mechanical and chemical integrity of the various elements making up the optical fiber. This is contrary to stripping techniques using a jet of hot air under pressure [5] or using a system of hot blades [6].

A particular object of the present invention is to propose a method enabling the cladding of a fiber to be stripped locally by locally removing the covering(s) from an optical fiber over a very wide range of lengths, while retaining high mechanical characteristics, and in particular good traction strength.

In the context of the invention, the segment to be stripped can be located equally well at the end of a fiber or in the middle of a segment of fiber.

A particular application of the present invention can lie in various methods of manufacturing filters based on Bragg gratings in all types of optical fiber (200 μm to 450 μm). Nevertheless, the method of the invention is not limited to this application, and its use can be extended to a multitude of applications that require local removal of the covering(s) on a fiber.

Another object of the present invention is to propose a method making it possible to gain access to the outside surface of the cladding without damaging it.

There are many occasions when technical constraints associated with the process of manufacturing components with optical fibers (in particular components based on Bragg gratings) and the mechanical performance that they must provide require physical contact with the core/cladding assembly of the silica fiber to be kept to a minimum.

In particular, the method of the invention must make it possible to photoinduce a grating in the optical fiber after it has been stripped. For this to be possible, the method must provide a stripped fiber that is completely clean after stripping.

In addition, as a subsidiary point, for the purpose of making it easier subsequently to reconstitute the covering(s) on the fiber, the invention preferably also provides stripped interfaces that are clean and regular.

The present invention achieves the above objects by means of a method comprising the following steps:

locally and mechanically removing a portion of the outer covering of the fiber;

placing a chemical solvent on the periphery of said zone of the fiber; and

mechanically removing the covering(s) weakened in this way.

The present invention also provides optical fibers as obtained in this way, in particular fibers having a Bragg grating in the stripped zone.

The present invention also provides a machine for implementing the above method. The machine comprises at least the following:

means suitable for locally and mechanically removing a portion of the outer covering of the fiber; and

means suitable for mechanically removing the covering from the periphery of the corresponding zone of the fiber, after the covering has been weakened by using a chemical solvent.

According to other characteristics of the present invention, the machine advantageously further comprises:

means for depositing a chemical solvent on the periphery of the treated zone of the fiber;

means suitable for fixing an optical fiber, and means suitable for guiding cutting tools in rotation about the fiber;

means suitable for fixing an optical fiber under constant tension; and/or

cutting means suitable for successively planing the outer surface of the fiber making a partial cut extending generally transversely to the axis of the fiber.

### BRIEF DESCRIPTION OF THE DRAWINGS

Other characteristics, objects, and advantages of the present invention will appear on reading the following detailed description and the accompanying drawings given by way of non-limiting example and in which:

FIG. 1, described above, is a diagrammatic cross-section view of a conventional optical fiber;

FIGS. 2, 3, and 4 are diagrams showing three successive basic steps in accordance with the present invention for stripping a segment of optical fiber;

FIGS. 5, 6, 7, and 8 are diagrams showing four successive optional steps in accordance with the present invention enabling high quality interfaces to be obtained at the ends of the stripped segment;

FIG. 9 is an overall exploded perspective view of a machine in accordance with the present invention;

FIG. 10 is a perspective view of first means for fixing an optical fiber;

FIG. 11 is a perspective view of second means for fixing an optical fiber in accordance with the present invention, designed to maintain constant tension therein;

FIG. 12 is an exploded perspective view of planing means in accordance with the present invention;

FIG. 13 is a side view of the planing means;

FIG. 14 is a section view showing the same planing means, on a section plane referenced XIV-XIV in FIG. 13;

FIG. 15 is a fragmentary perspective view of the planing means;

FIG. 16 is a cross-section view of an optical fiber support in accordance with the present invention;

FIG. 17 is an exploded perspective view of means in accordance with the invention for cutting a fiber transversely; and

FIGS. 18 and 19 are two perspective views showing said transverse cutting means respectively in an open position and in a closed position.

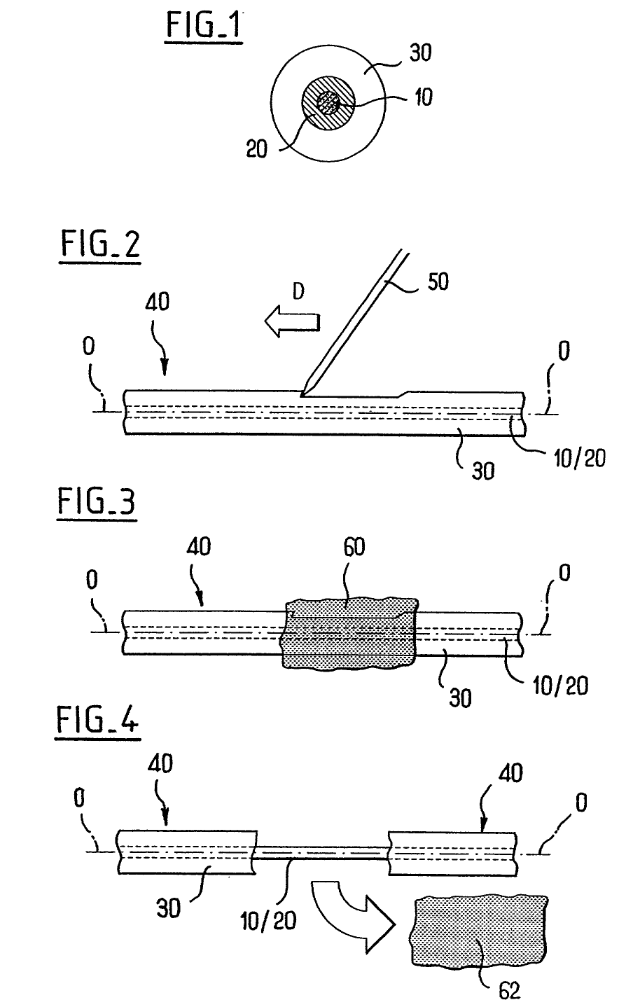

### MORE DETAILED DESCRIPTION

In the context of the present invention, prior to implementing the stripping method, the fiber is positioned in a support, which fiber is shown diagrammatically in accompanying FIGS. 2 et seq. More precisely, and preferably, the fiber 40 is positioned in a support having a precision V-groove for limiting physical contact with the assembly comprising the core 10 and the cladding 20 of the silica fiber 40.

Once the fiber 40 has been positioned in this way, a shaving of its covering 30 is removed using a blade 50. This operation of removing a shaving from the covering 30 is performed by shaving the assembly comprising the core 10 and the cladding 20 of the fiber 40 over the desired stripping distance but without ever touching said assembly. For this purpose, the blade 50 must be accurately positioned both concerning its angle of attack and concerning the distance between its cutting edge and said assembly comprising the core 10 and the cladding 20.

Still more precisely, during this removal operation, the blade 50 is set at an angle of less than 30° relative to the axis O-O of the fiber 40.

In FIG. 2, reference D represents the travel direction of the blade 50.

Once a shaving of the covering has been removed in this way, as shown in FIG. 3, the segment of fiber that is to be stripped, and that has already been subject to mechanical treatment, is covered in a chemical solvent 60. The purpose of the solvent is to degrade in part and to soften the covering zone 30 that coincides with the zone of the fiber that is to be stripped.

As shown diagrammatically in FIG. 4, all that then remains to be done is to mechanically withdraw the covering(s) 30 that has been weakened in this way.

The chemically-etched covering(s) is are preferably removed by means of a jet of dry air, or by means of a paintbrush dipped in ethanol, or by means of an ultrasound bath, thus revealing the assembly comprising the core 10 and the cladding 20 of bare fiber.

FIG. 4 represents under reference 62 the portion of the covering 30 that is removed in this way, said portion being soaked in solvent.

Nevertheless, in the context of the present invention, provision is preferably also made for the steps shown diagrammatically in FIGS. 5 to 8 for the purpose of making good interfaces at the ends of the stripped segment.

To do this, a blade 50 is positioned perpendicularly to the axis O-O of the fiber at each end of the segment that is to be stripped, and slightly beyond the portion that is withdrawn at the end of the steps shown in FIG. 4. The blades 50 used in the step of FIG. 5 must likewise be accurately positioned so as to ensure they never come into contact with the assembly comprising the core 10 and the cladding 20 of the fiber. Thereafter, relative rotation is established between the fiber 40 and the blades 50, preferably by rotating the fiber 40 about its own axis O-O, or possibly by rotating the blades 50 about the fiber 40 which is held stationary. This relative rotary motion creates a radial cut referenced 42 in FIG. 5 at the final stripped interfaces around the entire perimeter of the fiber.

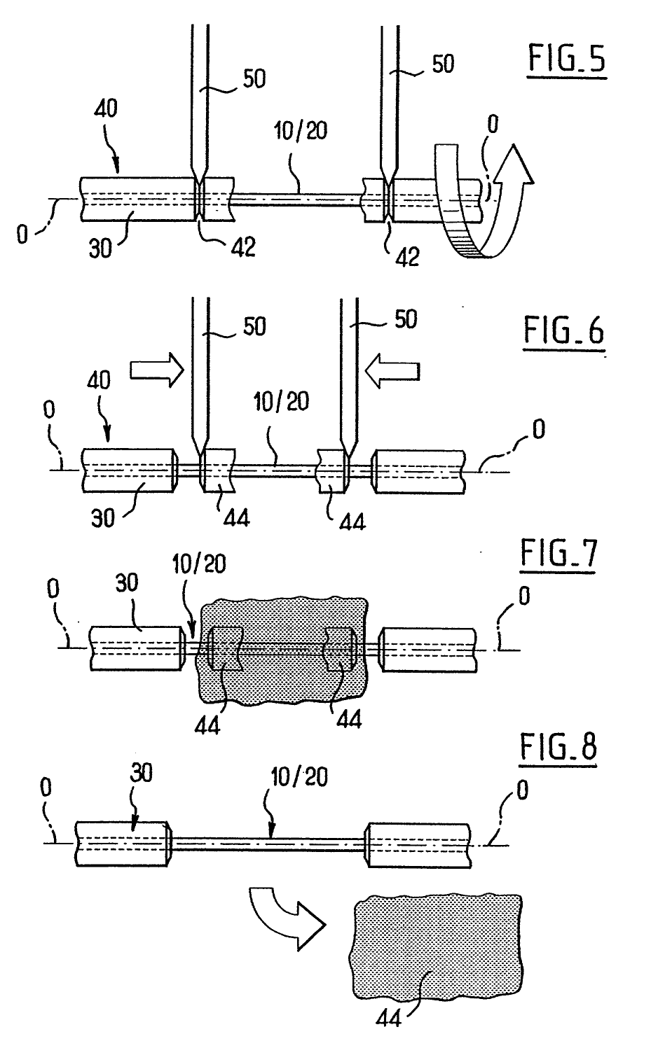

By moving the blades 50 in translation towards the center of the stripped zone, or by using any other equivalent means, the segments 44 as defined in this way by the cuts 42 are moved towards the center of the stripped zone (see FIG. 6).

A chemical solvent is then placed on each of the segments 44 (FIG. 7) and once the segments 44 have been weakened and softened in this way they are removed mechanically. In this case also, and preferably, this is done by means of a jet of dry air, or by means of a paintbrush dipped in ethanol, or by means of an ultrasound bath, so as to remove the segments 44 of chemically-etched and solvent-soaked covering.

As shown in FIG. 8, this provides a fiber 40 that is stripped along a segment that is well defined and that presents good interfaces.

The stripping method of the present invention makes it possible to determine accurately and repeatably the length of the stripped segments. It thus enables stripping to be performed entirely automatically, unlike the presently-known method which generally requires stripping to be performed manually.

The present invention also makes it possible to conserve a major fraction of the mechanical characteristics of the fiber (conserving abut 75% of its initial traction strength) by limiting physical contact with the assembly comprising the core 10 and the cladding 20 of silica. Finally, the method can be used equally well to strip short lengths, e.g. about 5 millimeters (mm) long, and long lengths (200 mm and longer).

Naturally, the present invention is not limited to the implementations described above, but extends to any variant in accordance with the spirit of the invention.

Naturally, assuming that the stripped zone is at an end of the fiber, then only one blade 50 is used in the step that corresponds to FIG. 5.

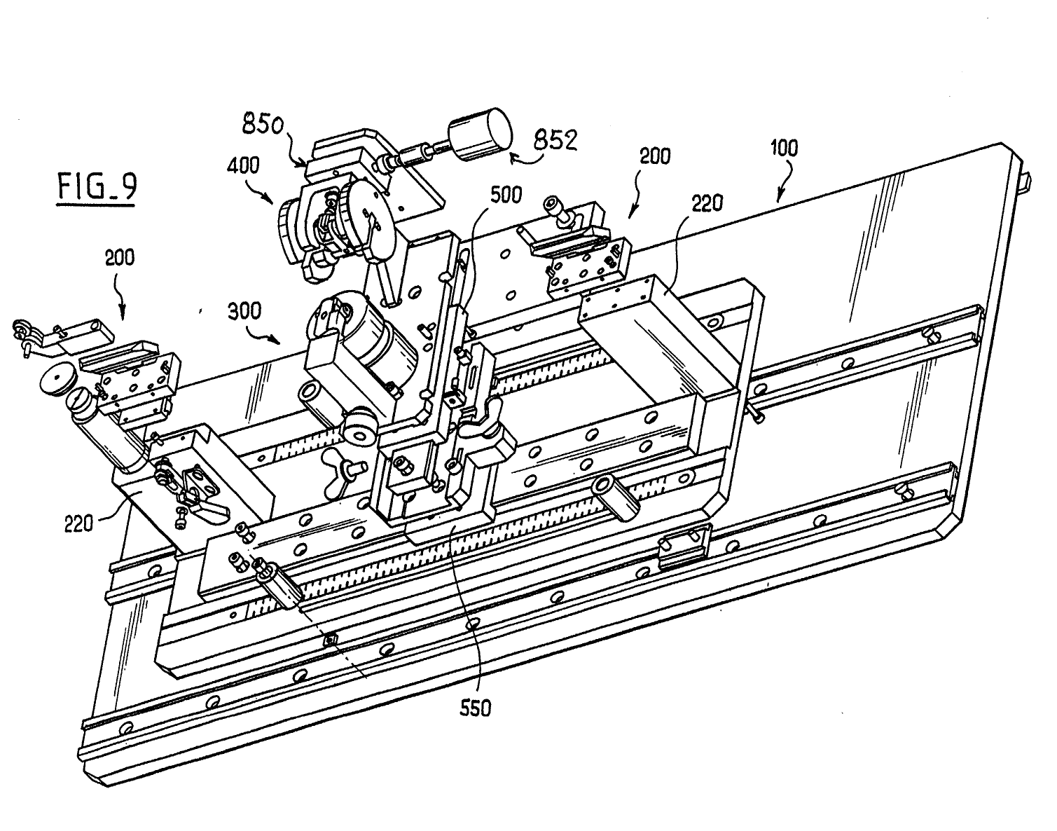

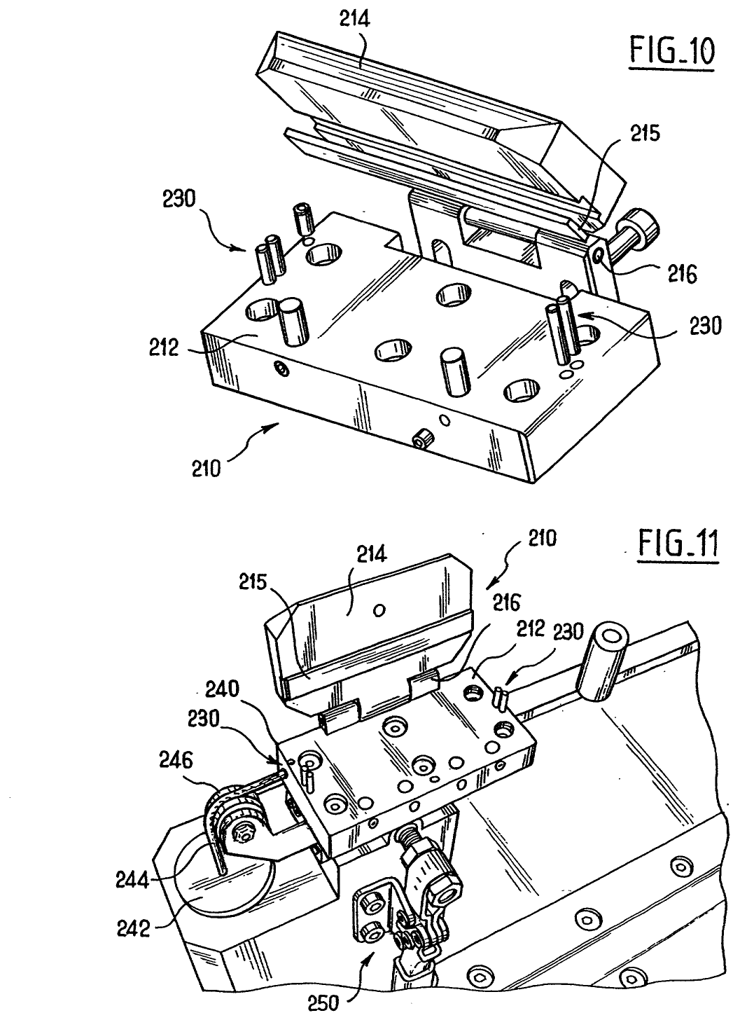

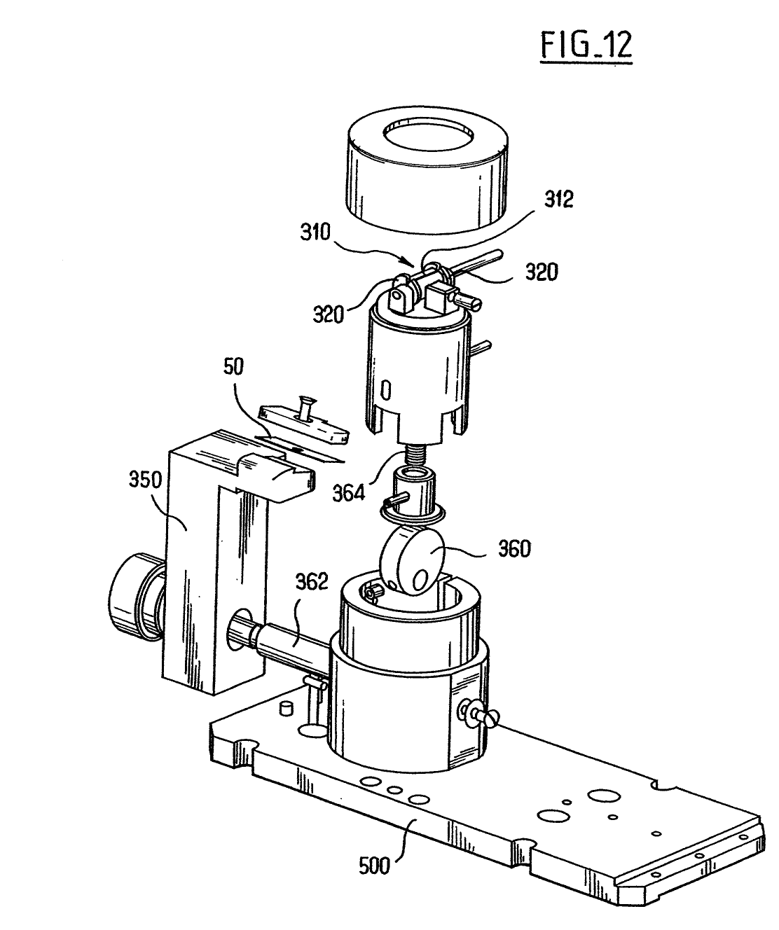

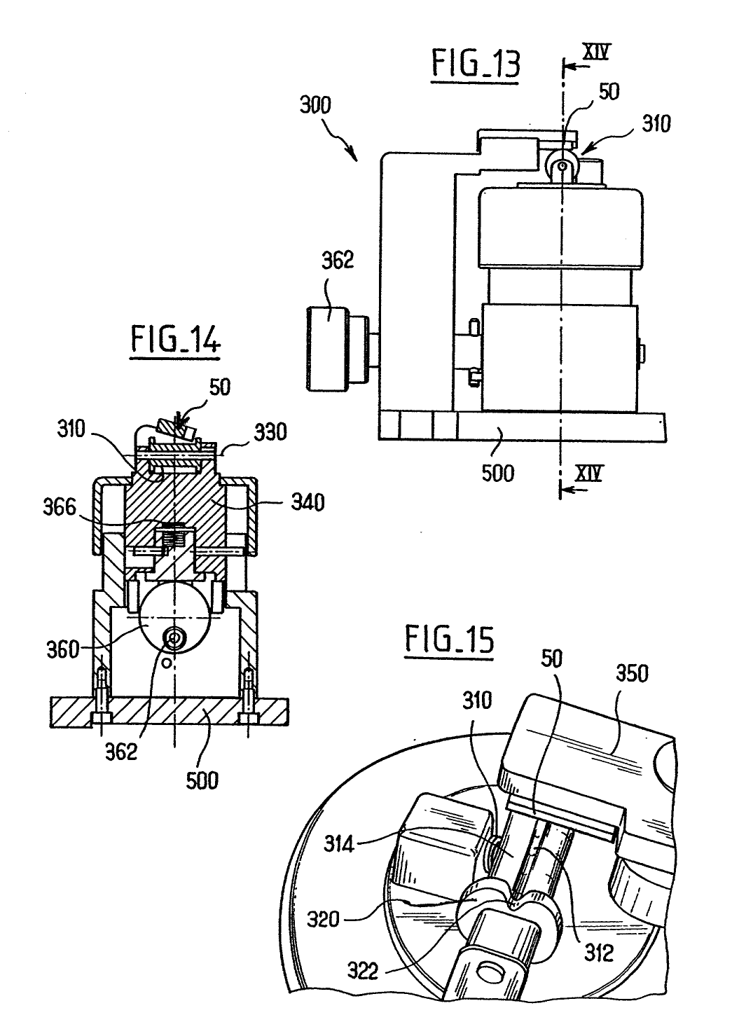

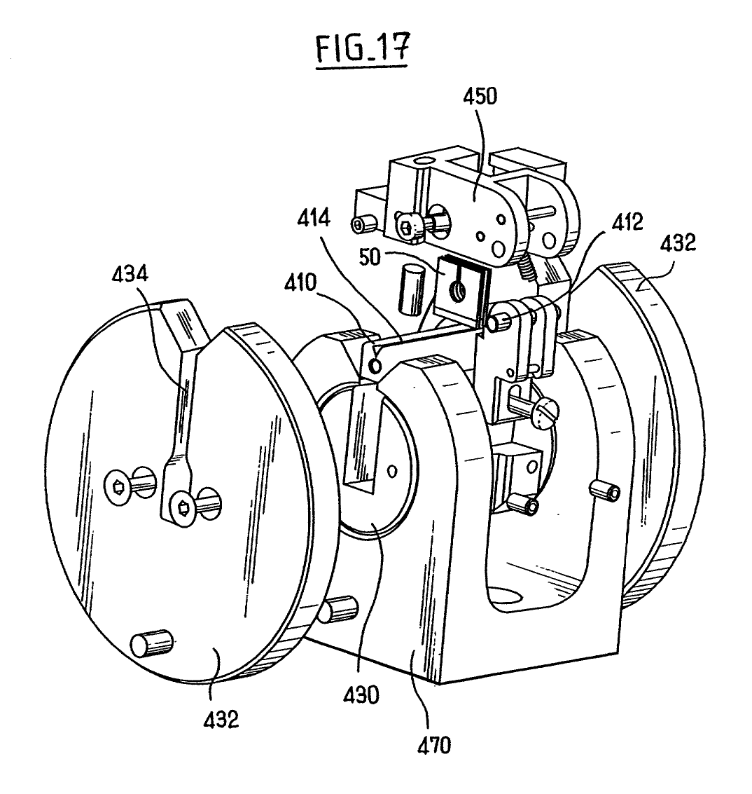

There follows a description of a fiber-stripping machine in accordance with the present invention and described with reference to accompanying FIGS. 9 to 19.

The fiber-stripping machine of the present invention essentially comprises a bedplate 100 carrying two optical fiber fixing means 200, a planing module 300, and a module 400 for shaping interfaces by cutting transversely to the optical fiber.

Where appropriate, the machine of the present invention can be also fitted with a chemical-etching module adapted to dispense the solvent that performs cleaning, together with associated means for blowing and sucking up the waste that is to be removed.

In a variant, the machine of the present invention can be provided with a binocular microscope for viewing the section of the fiber that is to be stripped. Such a microscope makes accurate positioning of the fiber in register with the cutting tools easier and it makes it possible to inspect the quality of the interfaces while stripping is taking place.

The means 200 are designed to hold the optical fiber relative to the bedplate 100, with the planing module 300 and the shaping module 400 being movable about the fiber.

Holding the fiber stationary in this way prevents harmful twisting and traction.

More precisely, the modules 300 and 400 are designed to operate on the segment of fiber that is tensioned between the two fixing means 200. The modules 300 and 400 are placed on a first slide 500, itself carried by a second slide 550.

The second slide 550 is guided in translation on the bedplate 100 in a direction parallel to the axis of the fiber. The first slide 500 is guided in translation on the second slide 550 in a direction that extends transversely relative to the displacement direction of the second slide 550 and relative to the fiber direction.

The two modules 300 and 400 are carried on the same slide 500, so all interference between the machining modules 300 and 400 is thus avoided in complete safety. These modules are moved so that one or other of them comes into register with the fiber. It is impossible for both of them to be moved simultaneously into register with the fiber.

The fixing means 200 are generally in the form of a clamp 210.

Each clamp 210 thus comprises two jaws 212 and 214 hinged about an axis 216.

The fixed jaw 212 of each clamp is carried on the top of a post 220. The top faces of the fixed jaws 212 are coplanar.

The hinge axes 216 are in axial alignment, and parallel to the axis of the fiber.

The bottom fixed jaw 212 preferably has two pairs of projecting pegs 230 located outside the pivoting jaws 214 and defining a system for guiding and centering the fiber.

The pivoting jaw 214 preferably has a strip of material 215 with a high coefficient of friction, e.g. an elastomer strip, for superposing on the fiber so as to guarantee that it is prevented from moving.

Each clamp 210 can be held in the closed position by any suitable means, e.g. magnets and/or screws, or by any equivalent means.

The person skilled in the art will understand that the fiber is held stationary with precision when guided by the pegs 230, with the top jaw 214 being closed and held against the bottom jaw 212 while the fiber is clamped between the lining 215 and the bottom jaw 212.

In the context of the present invention it is preferable for at least one of the clamps 212 to be adapted to maintain constant tension in the fiber throughout the stripping operations.

For this purpose, the bottom jaw 212 of the clamp 210 is mounted on a carriage 240 capable of sliding on the top of the post 220 in a direction parallel to the axis of the fiber. The carriage 240 is urged outwards away from the treatment zone by a weight 242. More precisely, the weight 242 is fixed to the carriage 240 by means of a cord 24 and the cord passes over a pulley wheel 246 carried by the post 220.

Naturally, the means for applying constant tension as formed by the carriage 240 and the weight 242 can be replaced by any equivalent means.

These means enable the fiber to be continuously subjected to a calibrated tension. They may it possible to avoid applying excessive traction during the various stages of stripping (planing and removal of the covering). They enable the stripping method of the present invention to be highly reproducible since the method is made independent of the manner in which an operator positions and tensions the fiber between its fixing points.

Where appropriate, the two clamps 210 can be provided with respective means for applying a constant force, e.g. using a weight in the manner described above. This makes it possible to provide pressure compensation, particularly when shaping the interfaces in both directions.

In the context of the present invention, each clamp 210 mounted on a carriage 240 is preferably also fitted with an assembly 250 for preventing any movement of the carriage 240 on request, by locking the carriage at the top of the associated post 220. Such locking means can be used while the fiber is being put into place.

The planing module 300 serves to remove a shaving of the outer covering from the fiber without touching the core of the fiber. It essentially comprises a support for the cutting blade 50.

The fiber support 310 has a fiber positioning groove 312 of V-shaped right section.

The groove 312 extends parallel to the axis of the fiber.

In the context of the present invention, the fiber support 310 is advantageously movable in translation vertically on the bedplate 100 so as to be brought into contact with the blade 50. It is recalled that the support 350 for the cutting blade 50 is movable in translation along the axis of the fiber by moving the support carriage 550.

The fiber support 310 performs several functions:

it holds the fiber beneath the blade 50 of the plane;

it serves as an abutment for the cutting blade 50 so that the blade 50 does not nick the core of the fiber; and

it serves as a guide running parallel to the axis of the fiber during movement of the plane 50.

The depth of the groove 312 matches the diameter of the fiber that is to be machined, so that only the covering of the fiber emerges from the groove.

In this context, the fiber support 310 is preferably removable and interchangeable.

The groove 312 leads to a flat 314 parallel to the cutting edge of the blade 50 and parallel to the axis of the fiber.

As can be seen in FIGS. 14 and 15 in particular, the support 310 preferably has end plates 320 of larger diameter at each end of the groove 312, each end plate having a V-notch 322 for guiding the groove 312 towards the fiber as the support 310 approaches the fiber.

In the context of the present invention, the support 310 is preferably mounted so as to be free to rotate on a base 340 about an axis 330 that is parallel to the axis of the fiber.

By having the notches 332 in the end plate 320, this disposition serves to center the support 310 automatically on the fiber.

In use, the support 310 is brought beneath the segment of fiber that is to be stripped, with the blade 50 of the plane being placed above it. After pre-centering by means of ht V-notches 322, the support 310 is positioned with precision by aligning the flat 314 on the cutting edge of the blade 50.

The blade 50 is brought to bear against the fiber and it cuts into the covering until it comes into abutment against the flat 314.

This serves to position both the optical fiber and the cutting tool 50 simultaneously and automatically.

It then suffices to move the slide 550 parallel to the axis of the fiber so as to remove the desired shaving from the outer covering of the fiber.

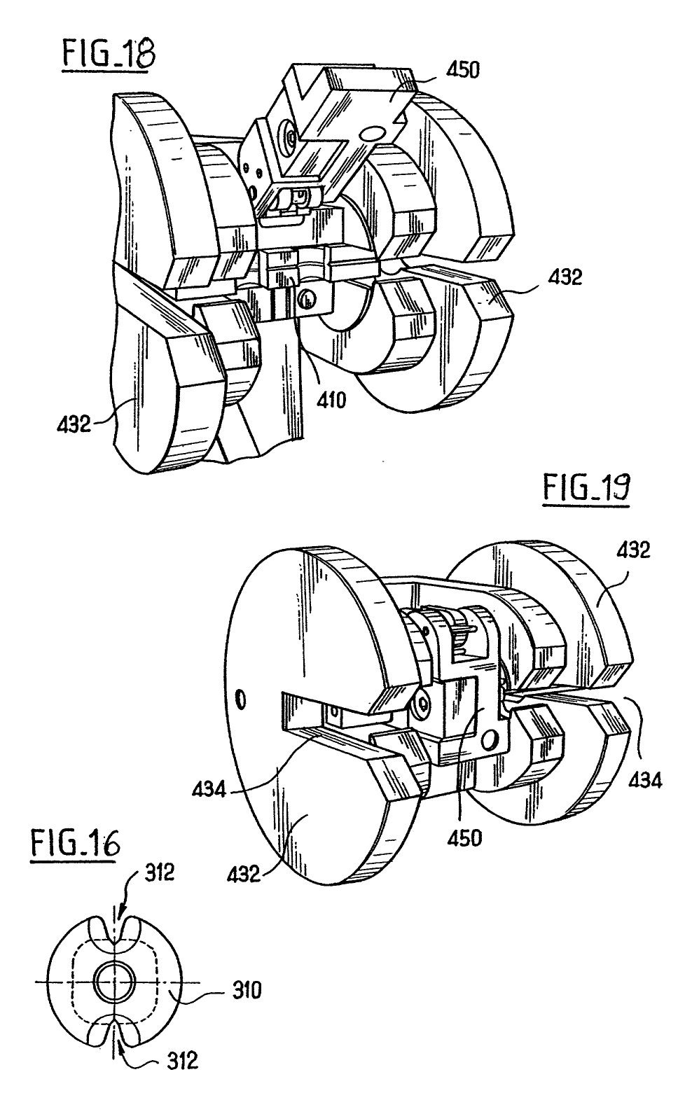

The groove 312 preserves the integrity of the core of the fiber during planing.

Where appropriate, and as can be seen in the variant of FIG. 16, the support 310 can be provided with a plurality of grooves 312 of different depths adapted to the various outside diameters and thicknesses of the coverings of fibers that are to be treated. Thus, FIG. 16 shows a cylindrical support 310 having two diametrically opposite grooves 312 in its outside surface.

Naturally, in the context of the present invention, the support 310 can be provided with some number of grooves 312 that is greater than two. More generally, the support 310 can have any appropriate section and need have only a single positioning V in a manner comparable to the element 410.

The means for moving the support 310 up and down can be implemented in numerous ways. As shown in the accompanying figures, these means are formed by an eccentric 360 controlled by a shaft 362 for urging the base 340 that acts as a seat for the support 310, with a spring 366 being interposed.

The module 400 for shaping the interfaces essentially comprises two portions:

a part 410 which serves to align and to stop the cutting blades 50 (in a manner analogous to the V described above); and

a part 450 carrying a set of cutting blades 50 that can be caused to rotate about the fiber, and to move in translation parallel to the axis of the fiber.

In the present invention, the cutting block 450 advantageously has a plurality of parallel cutting blades, e.g. two, three, four or more cutting blades that are spaced apart by a small distance. This distance is preferably variable at will using spacers of various thicknesses. This disposition improves removal of the annular section at the end of the stripped zone.

The two parts 410 and 450 are hinged like a clamp about an axis 412 parallel to the axis of the fiber.

The part 410 is provided with a V-groove segment 414. As can be seen in FIG. 18 the part 410 is preferably thus provided with a plurality of V-groove segments 414 in alignment.

The two parts 410 and 450 are mounted on a block 430 which is mounted to rotate on a base 470 secured to the slide 500.

The block 430 is preferably provided with end plates 432 having lateral grooves 434 in alignment on the groove 414.

The pivoting part 450 is held on the fixed part 410 by any appropriate means, for example by magnets and/or screws, or by any other appropriate means.

In this case also, the part 410 defining the fiber positioning V is preferably removable and interchangeable so that the depth of the groove 414 always matches the size of the fiber, thus ensuring that the core of the fiber is never injured. The depth of the groove 414 defines the depth of cut, and in use, the blades 50 come into abutment against the outside flanks thereof.

The module 400 is advantageously mounted to move in translation parallel to the axis of the fiber on a support plate 850. Movement of the module 400 in translation can be controlled by any appropriate means, e.g. a screw system 852.

In use, the block 430 is brought against the fiber which becomes centered in the groove 414. The blade-carrying pivoting part 450 is closed against the fiber. The blades 50 then cut into the covering of the fiber.

The block 430 is then rotated about the axis of the fiber so as to make a circular cut in the fiber.

The block 430 can then be moved in translation parallel to the axis of the fiber by actuating the means 852 so as to tear away the residue of covering from the edge of the stripped section.

The various moving members of the machine of the present invention can be actuated either manually or automatically. By way of example, in the embodiment shown in the accompanying figures, these means can be caused to move in rotation and in translation by screws actuated by means of a knob by an operator. The screws step down the amount of movement, thereby making it much more regular. This disposition makes it possible to achieve excellent reproducibility of the stripping method.

Nevertheless, in a variant, all of these movements can be automated using actuators or motors.

Naturally, the blade-carrier blocks must be removable so as to enable the sets of blades 50 to be replaced once they are worn.

Where appropriate, the angle of inclination of the cutting blade 50 relative to the axis of the fiber can be adjustable.

In another variant, the cutting blades 50 can be heated so as to improve cutting through the covering.

Abutments are preferably provided on the bedplate 100 to limit the amplitude of displacement of the slides 500 and 550, in particular the amplitude of the displacement of the slide 550 along the axis of the fiber. The machine preferably also has means, e.g. screws, for selectively locking the slides 500 and 550 in selected positions.

To use the machine of the present invention, as described above, the procedure is preferably essentially as follows:

The segment of fiber to be treated is positioned and centered between the two clamps 210 and the clamps are closed.

The module 300 is positioned in register with the fiber at one end of the segment that is to be planed.

The support 310 is raised so that it supports the fiber in the groove 312.

The module 300 is then moved in translation along the axis of the fiber over the desired distance so as to remove a shaving of fiber covering.

The support 310 is then lowered.

A chemical solvent is applied and the weakened portion of fiber is withdrawn.

The module 400 is in turn engaged in register with the fiber. It needs to be positioned with precision in register with the axial zone of the fiber where a good interface is to be provided.

The pivoting part 450 is closed onto the part 410 and the block 430 is then rotated through 3 to 4 turns.

The module 400 is then moved in translation to shift the stripped pieces towards the center of the machined zone.

The operations of the module 400 are then repeated at the second interface.

The remains of the shifted covering are then removed. The interface is then preferably cleaned, e.g. using a brush dipped in ethanol. Where appropriate, this cleaning step can be preceded by a chemical etching or stripping step, in which case it is preferable to remove the chemical stripper using a solvent. This chemical stripping step can optionally be obtained using the same chemical as that which is used for cleaning, e.g. ethanol.

Nevertheless, it should be observed that in some configurations the inventors have found that there is no need to rotate the module 400 before moving it in translation. Under those circumstances, merely nicking the fiber covering when the pivoting part 450 is closed on the part 410 is sufficient prior to moving the module 400 in translation.

In the context of the present invention, the module 400 for shaping the interfaces preferably has a plurality of parallel blades. This disposition makes it possible to limit the amount of force applied to the blades, in particular when they are moved parallel to the axis of the fiber.

The stripping machine of the present invention is equally capable of stripping an intermediate section of optical fiber or an end segment thereof.

The machine makes it easy to adjust the length of the fiber that is to be stripped in the range a few millimeters to several centimeters.

The machine of the present invention makes it possible to avoid weakening the optical fiber and consequently to obtain a fiber whose traction strength is greater than that of prior art fibers. The present invention has thus made it possible to obtain fibers presenting traction strength greater than 1.8 kilograms (kg) whereas most conventional equipment, generally based on stripping pliers, does not enable traction strength to be obtained above 600 grams (g).

The present invention thus makes it possible to improve productivity when manufacturing components on an optical fiber, by reducing the reject rate.

The method and the machine of the present invention make the following possible, in particular:

the stripped fiber is very clean, thus improving the quality of components photoinduced in the fiber;

the quality of the interface between a stripped section and the covering is very good;

the core of the stripped core is preserved;

stripping is performed with good reproducibility;

the resulting fibers have good traction strength; and

the reject rate of components is low.

Naturally, in the context of the present invention, the concept of a “slide” should be understood broadly as covering any system of slideways, support plates, or linear displacement blocks, or guide rails.

[1] D. Varelas, “Mechanical reliability of optical fiber Bragg gratings”, Ph.D. thesis, University of Lausane (Switzerland), 1998.

[2] S. Boj, “Réalisation de filtres sélectifs en fréquence intégrés dans les fibres optiques et applications” [Making frequency-selective filters in optical fibers, and applications therefor], Ph.D. thesis, University of Lille, 1995.

[3] Technical documentation for Vytran Corporation re-sheathing machines, 1999.

[4] General products catalog of Ses-Sterling Department I.

[5] A novel method of removing optical fiber coating with hot-air steam, Department of Information and Communications, Kwangju Institute of Science and Technology, 572 Sangamdong, Kwangsan-ku, Kwangju, 506-712, Korea.

[6] General products catalog of Ses-Sterling Department II.

1/ A method of stripping an optical fiber, the method comprising the steps consisting in:
locally and mechanically removing a portion of the outer covering of the fiber;
placing a chemical solvent on the periphery of said zone of the fiber; and
mechanically removing the covering(s) weakened in this way.

2/ A method according to claim 1, wherein the step of locally and mechanically removing a portion of the outer covering of the fiber is a step of cutting off a shaving of the covering.

3/ A method according to claim 1, wherein the step of locally and mechanically removing a portion of the outer covering of the fiber is implemented using a blade extending at an angle of less than 30° relative to the axis O-O of the fiber.

4/ A method according to claim 1, wherein the fiber is previously positioned in a precision V-shape.

5/ A method according to claim 1, further comprising the steps consisting in making an incision in the covering of the fiber, slightly outside the previously stripped zone, using a blade that is positioned perpendicularly to the axis of the fiber, and in eliminating the covering segment defined in this way.

6/ A method according to claim 5, further comprising the step which consists in establishing relative rotation between the blade and the fiber, prior to eliminating the defined segment of covering.

7/ A method according to claim 5, further comprising making two incisions in the covering of the fiber respectively at each end of the previously stripped zone.

8/ A method according to claim 5, wherein the step of eliminating the incision-defined segment(s) of covering includes the step of mechanically moving said segment towards the center of the stripped zone, e.g. by urging it by means of the cutting blade.

9/ A method according to claim 5, wherein the step of removing the segment defined by an incision comprises depositing a chemical solvent.

10/ A method according to claim 1, wherein each blade used is positioned accurately so as to avoid touching the assembly constituted by the core and the cladding of the fiber.

11/ A method according to claim 1, further comprising a step of mechanically removing a portion of fiber covering that has previously been weakened by chemical etching, by using a jet of dry air.

12/ A method according to claim 1, further comprising a step of mechanically removing a portion of covering previously etched by chemical solvent, by using a brush dipped in ethanol.

13/ A method according to claim 1, further comprising the step of mechanically removing a portion of fiber covering previously weakened by chemical etching, by using an ultrasound bath.

14/ An optical fiber partially stripped by implementing a method according to claim 1.

15/ A fiber according to claim 14, wherein the stripped zone is an intermediate zone of the fiber.

16/ A fiber according to claim 14, wherein the stripped zone is an end zone.

17/ A fiber according to claim 14, wherein the fiber includes a Bragg grating in its stripped zone.

18/ A machine for stripping an optical fiber by implementing the method according to claim 1, the machine comprising means suitable for locally and mechanically removing a portion of the outer covering of the fiber, and means suitable for mechanically removing the covering from the periphery of the corresponding zone of the fiber, after the covering has been weakened by using a chemical solvent.

19/ A machine according to claim 18, further comprising means for depositing a chemical solvent on the periphery of the treated zone of the fiber.

20/ A machine according to claim 18, further comprising means suitable for fixing an optical fiber, and means suitable for guiding cutting tools in rotation about the fiber.

21/ A machine according to claim 18, further comprising means suitable for fixing an optical fiber under constant tension.

22/ A machine according to claim 18, further comprising cutting means suitable for successively planing the outer surface of the fiber making a partial cut extending generally transversely to the axis of the fiber.

23/ A machine according to claim 18, further comprising a bedplate carrying two means for fixing an optical fiber, a planing module, and a module for shaping interfaces by cutting the optical fiber transversely.

24/ A machine according to claim 18, further comprising blowing and/or sucking means for removing the waste to be removed.

25/ A machine according to claim 18, including a microscope.

26/ A machine according to claim 18, further comprising two slides suitable for sliding in two orthogonal directions relative to a bedplate, a first slide having cutting tools itself being slidably mounted on the second slide.

27/ A machine according to claim 18, including a planing tool and a tool for shaping interfaces, both tools being secured to a common slide.

28/ A machine according to claim 18, including fixing means in the form of a clamp.

29/ A machine according to claim 18, including fixing means defining a system for guiding and centering a fiber.

30/ A machine according to claim 18, including fixing means defining a system for guiding and centering a fiber, said system being in the form of at least one pair of projecting pegs.

31/ A machine according to claim 18, including fixing means in the form of a clamp comprising a strip of material having a high coefficient of friction on one of its jaws.

32/ A machine according to claim 18, including at least one fixing means suitable for moving on a carriage urged along the axis of the fiber under constant force.

33/ A machine according to claim 18, including at least one fixing means suitable for moving on a carriage connected to a weight via a cord passing over a pulley.

34/ A machine according to claim 32, including means suitable for selectively preventing the carriage that supports the fixing means from moving.

35/ A machine according to claim 18, including a planing module having a fiber support provided with a positioning groove of V-shaped right section.

36/ A machine according to claim 35, wherein the fiber support is mounted to move vertically in controlled manner relative to a planing blade.

37/ A machine according to claim 35, wherein the groove leads to a flat.

38/ A machine according to claim 35, wherein the fiber support is mounted to rotate on a post about an axis parallel to the axis of the fiber.

39/ A machine according to claim 35, wherein the fiber support is interchangeable.

40/ A machine according to claim 35, wherein the fiber support includes at least one end plate provided with a V-notch at one of the ends of the groove.

41/ A machine according to claim 35, wherein the fiber support has a plurality of grooves of different depths adapted to the outside diameters and covering thicknesses of fibers to be treated.

42/ A machine according to claim 35, wherein the fiber support is associated with an eccentric for displacing it.

43/ A machine according to claim 18, including a module for shaping interfaces, the module comprising a part having means for receiving a fiber, means for aligning and coming into abutment with a cutting blade, and a part which carries at least one cutting blade.

44/ A machine according to claim 43, wherein the part which carries at least one cutting blade can be actuated to rotate about the fiber.

45/ A machine according to claim 43, wherein the part which carries at least one cutting blade is capable of being actuated to move in translation parallel to the fiber.

46/ A machine according to claim 43, wherein the shaping module includes a plurality of parallel cutting blades.

47/ A machine according to claim 43, wherein said two parts are hinged like a clamp.

48/ A machine according to claim 43, wherein the part including fiber-receiving means presents a V-groove of depth adapted to the diameter of the fiber.

49/ A machine according to claim 43, wherein the two parts are mounted on a block which is mounted to rotate on a base carried by a slide capable of moving in translation parallel to the axis of the fiber.

50/ A machine according to claim 49, including an intermediate slide mounted to move in translation on the first-mentioned slide transversely to the axis of the fiber and itself carrying the base.

51/ A machine according to claim 43, wherein the shaping module includes a removable fiber-positioning part.

52/ A machine according to claim 18, including removable blade-carrier blocks.

53/ A machine according to claim 18, including means for adjusting the inclination of cutting blades.

54/ A machine according to claim 18, including heating cutting blades.

55/ A machine according to claim 18, including stops limiting the amplitude of the displacement of the slides carrying the cutting tools.
